(19) United States
(12) Patent Application Publication
(10) Pub. No.: US 2010/0186995 A1
(43) Pub. Date: Jul. 29, 2010

(54) Connecting device for cables and jumper wires

(76) Inventor: Shih-Kun Yeh, Luchu Hsiang (TW)

Correspondence Address: Jackson Intellectual Property Group PLLC, 106 Starvale Lane, Shipman, VA, 22971, US

(21) Appl. No.: 12/149,690

(22) Filed: May 6, 2008

(51) Int. Cl. H01R 12/10; H01R 12/04

(52) U.S. Cl. 174/254; 174/261

(57) ABSTRACT

A connecting device for cables and jumper wires according to the present invention at least comprises a flexible flat cable and a second connecting member, wherein the flexible flat cable and the second connecting member are linked to each other and positioned by a circuit board for turn-on, and the to circuit board is provided thereon with a plurality of circuits, and the flexible flat cable is provided with a plurality of first pins connected to each of the circuits, and the second connecting member is also provided with a plurality of second pins connected to each of the circuits, and the arranging order of each first pin differs from that of each second pin so that each circuit on the circuit board can provide a jumper connection between the flexible flat cable and the second connecting member.

### BACKGROUND OF THE INVENTION

(a) Field of the Invention

The present invention relates to a connecting device for cables and jumper wires. It aims to provide a connecting device for cables and jumper wires designed to form a jumper connection among a flexible flat cable and other connecting members by each circuit on a circuit board.

(b) Description of the Prior Art

A flexible flat cable (FFC) is a data cable made by laminating a PET insulating material and an extremely thin tin-plated flat copper wire, which has the characteristics of low price, small thickness, flexibility, foldability and the ease of forming electromagneticinterference (EMI) shielding. It has been widely applied in the connection of movable members in many related electrical products to main boards.

For example, in the case of a notebook computer, a flexible flat cable can be applied in the signal connection of a liquid crystal display (LCD) of the notebook computer to a main board. Since a flexible flat cable has the features of high flex resistance, cheapness and the like, in consideration of the cost, it preferably matches the superiority of a notebook computer that can respond to the market demand rapidly, even has a trend of substituting for flexible printed circuit (FPC) boards.

The use of a common flexible flat cable is as shown in FIG. 1. A flexible flat cable 11 connects a first main body 12 and a second main body 13. The first and second main bodies 12, 13 are provided thereon with a plurality of pins (not shown), and the pins are linked to each other via the flexible flat cable 11 to transmit signals or electricity. Wherein the pins on the first and second main bodies 12, 13 may be respectively arranged in different order to form jumper wires. For example, if the first pin of the first main body desires to transport a signal or electricity to the third pin of the second main body, the connection cannot be exactly completed via the flexible flat cable 11. Due to the parallel arrangement of a plurality of transmission lines 111 on the flexible flat cable 11, a jumper connection among each of the pins on the first and second main bodies 12, 13 cannot be achieved.

Therefore, a coaxial line structure is also present in the market, as illustrated in FIG. 2. The pins (not shown) of the first and second main bodies 12, 13 are linked to each other by a plurality of coaxial lines 14 to transmit signals or electricity. When the pins on the first and second main bodies 12, 13 are respectively arranged in different order to form jumper wires, for example, the first pin of the first main body would like to send a signal or electricity to the third pin of the second main body, the connection can be formed by making one end of a coaxial line connected to the first pin of the first main body and making the other end thereof connected to the third pin of the second main body. Each of the coaxial lines 14 can be wrapped in an insulating member 15 to hide the raveled coaxial lines, however, the coaxial lines are not suitable for a smaller space and have less applicability due to their poorer flex resistance.

### SUMMARY OF THE INVENTION

The primary objective of the present invention is to provide a connecting device for cables and jumper wires designed to form a jumper connection among a flexible flat cable and other connecting members by each circuit on a circuit board.

To achieve the above objective, the entire connecting device for cables and jumper wires at least comprises a flexible flat cable (FFC) and a second connecting member (e.g. a coaxial line or a flexible flat cable), wherein the flexible flat cable and the second connecting member are linked to each other and positioned by a circuit board for turn-on, and the circuit board is provided thereon with a plurality of circuits, and the flexible flat cable is provided with a plurality of first pins connected to each of the circuits, and the second connecting member is also provided with a plurality of second pins connected to each of the circuits, and the arranging order of each first pin differs from that of each second pin so that each circuit on the circuit board can provide a jumper connection between the flexible flat cable and the second connecting member.

### BRIEF DESCRIPTION OF THE DRAWINGS

FIG. 1 is a schematic view showing a structure of a conventional flexible flat cable to serve as a connecting device.

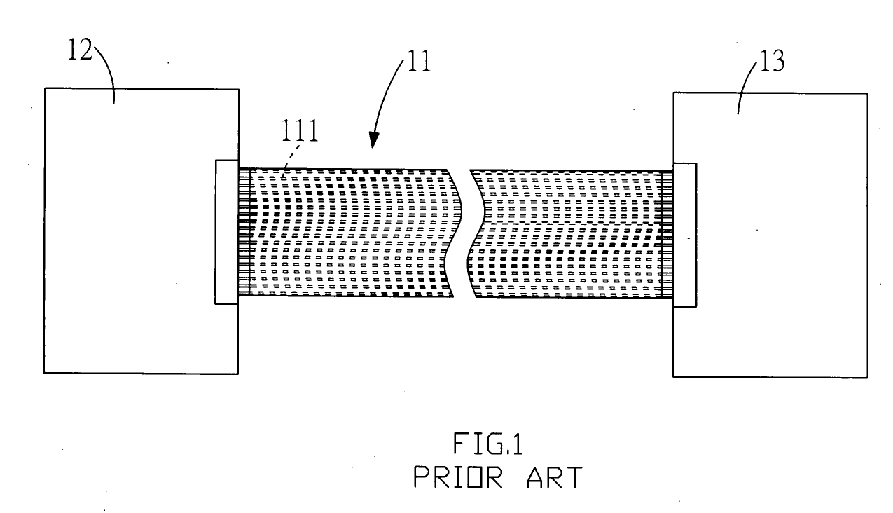

FIG. 2 is a schematic view showing a structure of conventional coaxial lines to serve as a connecting device.

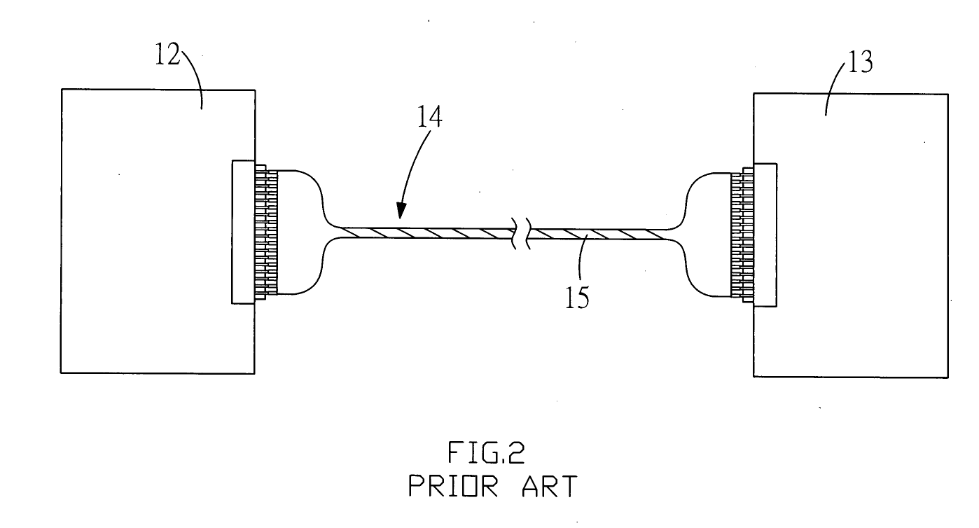

FIG. 3 is a schematic exploded view showing the structure of a connecting device for jumper wires according to a first embodiment of the present invention.

FIG. 4 is a schematic view showing a structure of a circuit board and each pin according to the present invention.

FIG. 5 is a schematic view showing a structure of the interconnection of a connecting device for jumper wires and two main bodies according to a first embodiment of the present invention.

FIG. 6 is a schematic view showing a structure of the interconnection of a connecting device for jumper wires and two main bodies according to a second embodiment of the present invention.

FIG. 7 is a schematic view showing a structure of the interconnection of a connecting device for jumper wires and two main bodies according to a third embodiment of the present invention.

FIG. 8 is a schematic view showing a structure of the interconnection of a connecting device for jumper wires and two main bodies according to a fourth embodiment of the present invention.

FIG. 9 is a schematic view showing a structure of the interconnection of a connecting device for jumper wires and two main bodies according to a fifth embodiment of the present invention.

FIG. 10 is a schematic view showing a structure of a connecting device for jumper wires according to a sixth embodiment of the present invention.

FIG. 11 is a schematic view showing a structure of the interconnection of a connecting device for jumper wires and two main bodies according to a sixth embodiment of the present invention.

FIG. 12 is a schematic view showing another structure of the interconnection of a connecting device for jumper wires and two main bodies according to a sixth embodiment of the present invention.

### DETAILED DESCRIPTION OF THE PREFERRED EMBODIMENTS

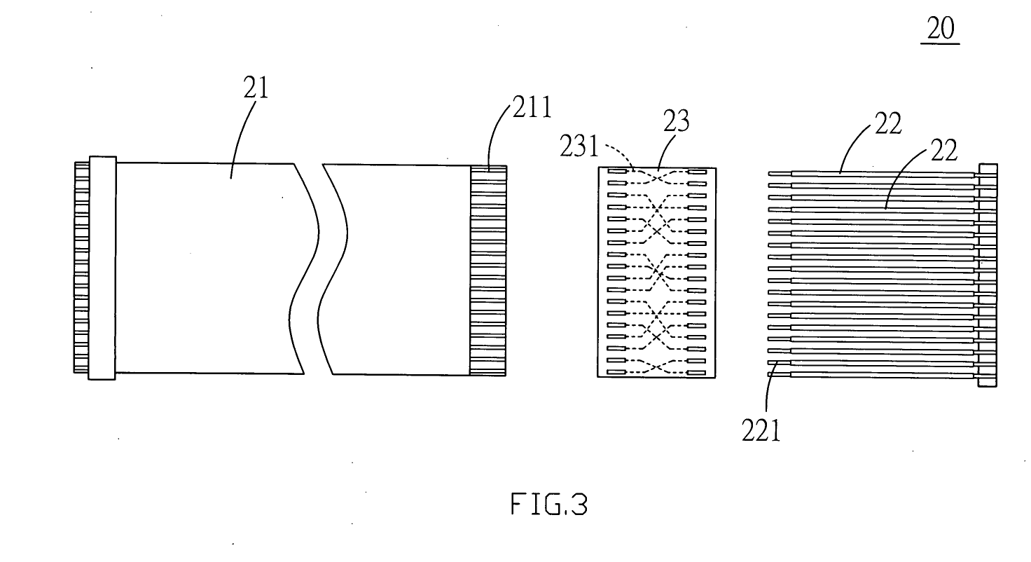

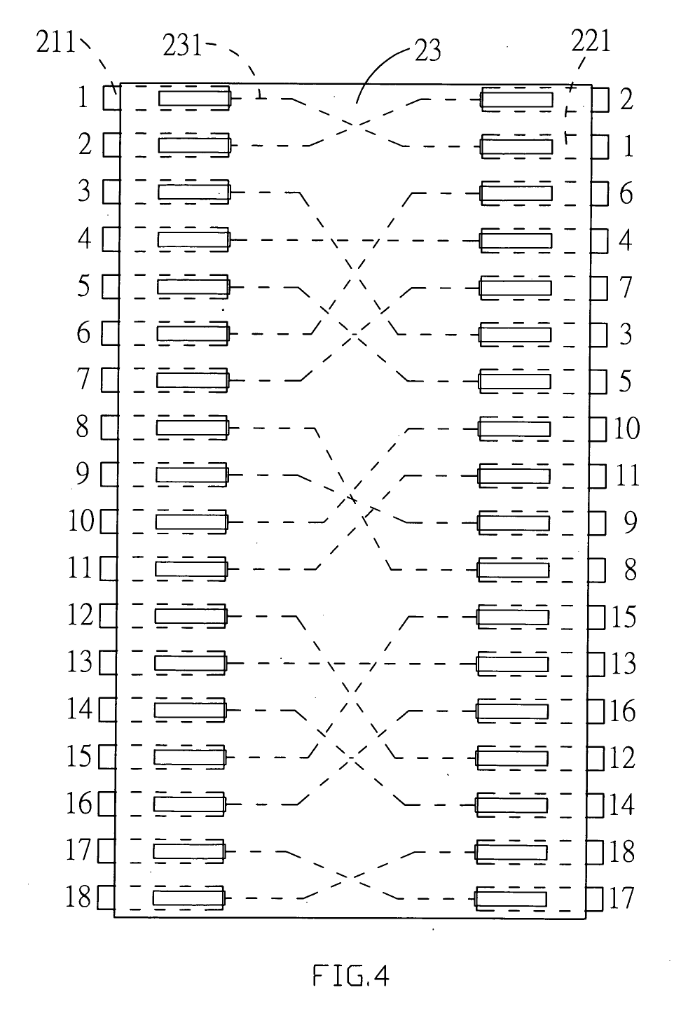

The structure of the connecting device 20 for cables and jumper wires according to the present invention, as illustrated in FIG. 3, at least comprises a flexible flat cable 21 and a second connecting member. In the embodiment as shown in the drawing, the second connecting member can be coaxial lines 22, wherein the flexible flat cable 21 and the coaxial lines 22 are linked to each other and positioned by a circuit board 23 for turn-on, and the circuit board 23 is provided thereon with a plurality of circuits 231.

Wherein the flexible flat cable 21 is provided with a plurality of first pins 211 connected to each of the circuits 231, and the coaxial lines 22 are also provided with a plurality of second pins 221 connected to each of the circuits 231, and the arranging order of each first pin 211 differs from that of each second pin 221. Also, referring to FIG. 4, for example, the arranging order of each first pin 211 is 1, 2, 3, 4, 5, 6, 7, 8, 9, 10, 11, 12, 13, 14, 15, 16, 17, 18, and the arranging order of each second pin 221 is 2, 1, 6, 4, 7, 3, 5, 10, 11, 9, 8, 15, 13, 16, 12, 14, 18, 17. The circuits 231 on the circuit board 23 are designed to connect each first pin 211 with each corresponding second pin 221 such that the arrangement of the circuits 231 on the circuit board 23 can provide a jumper connection among the flexible flat cable 21 and the coaxial lines 22.

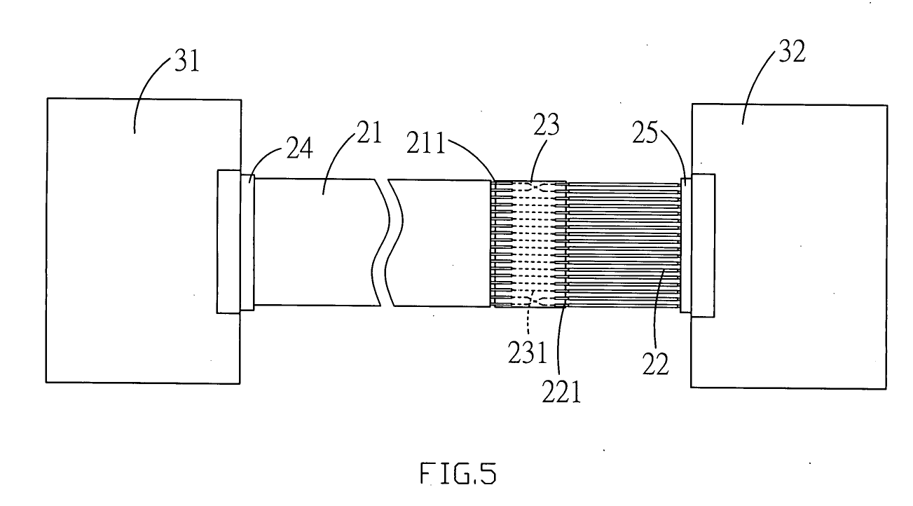

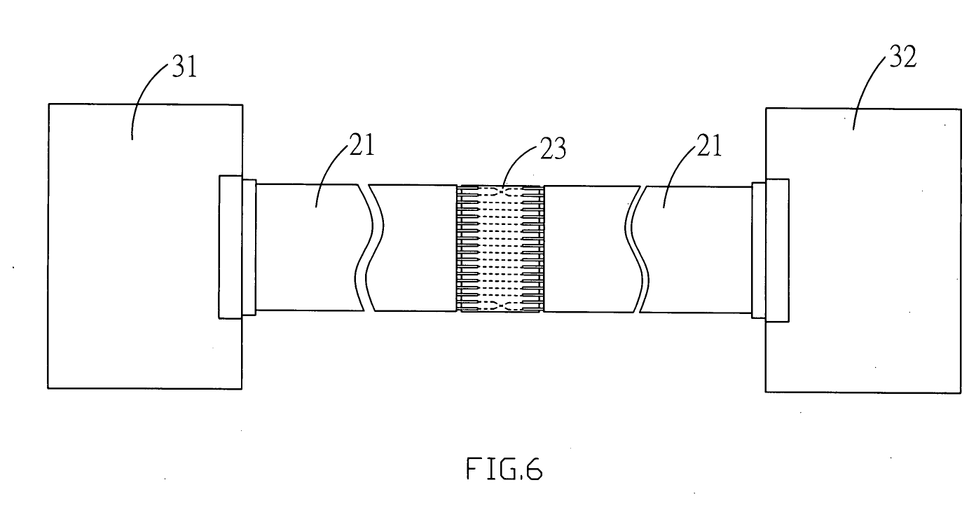

When the entire connecting device for cables and jumper wires is applied to connect two main bodies, as illustrated in FIG. 5, a first connecting body 24 is disposed at the other end of the flexible flat cable 21 opposed to the coaxial lines 22. The flexible flat cable 21 is connected to a first main body 31 via the first connecting body 24. A second connecting body 25 is disposed at the other end of the coaxial lines 22 opposed to the flexible flat cable 21, and the coaxial lines 22 are connected to a second main body 32 via the second connecting body 25 to connect and transmit signals or electricity between the first main body 31 and the second main body 32. The above first and second connecting bodies can be an ODD (Optical Disc Drive), a SATA (Serial ATA), a HDMI (High-Definition Multimedia Interface), a USB, a D-sub or a LVDS transmission interface. It is understood that the second connecting member can also be a flexible flat cable 21, as illustrated in FIG. 6.

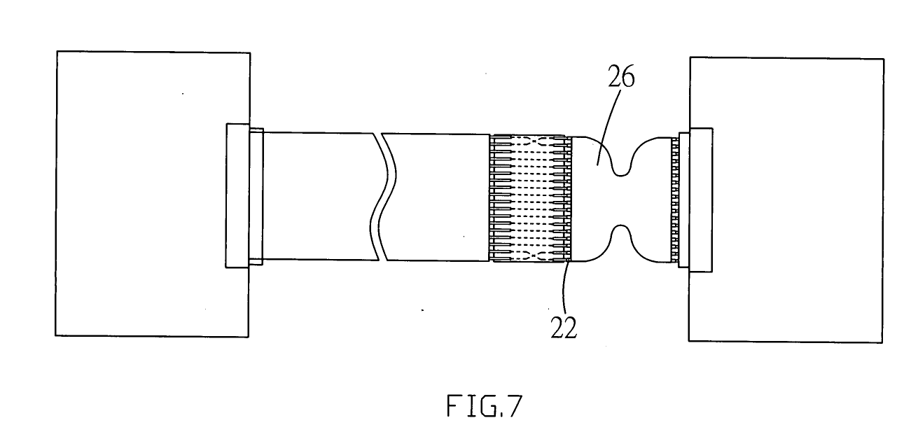

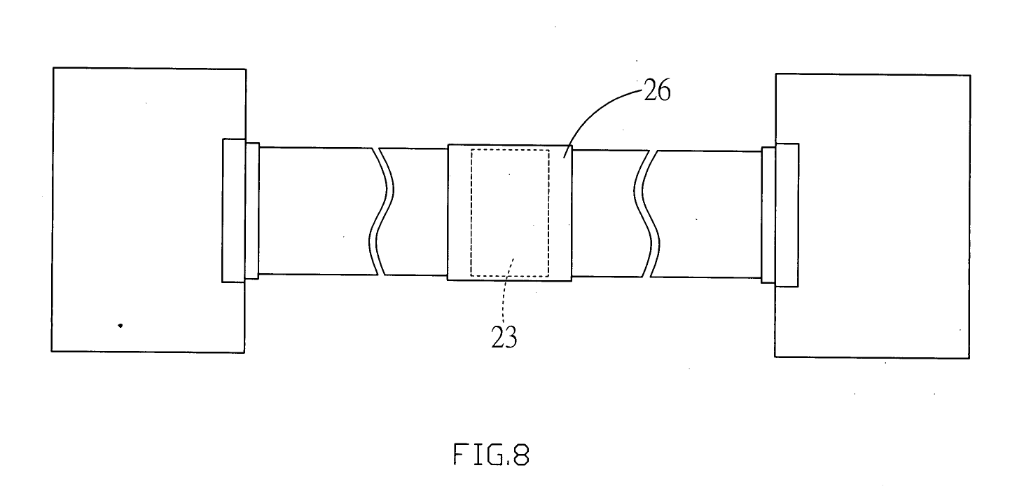

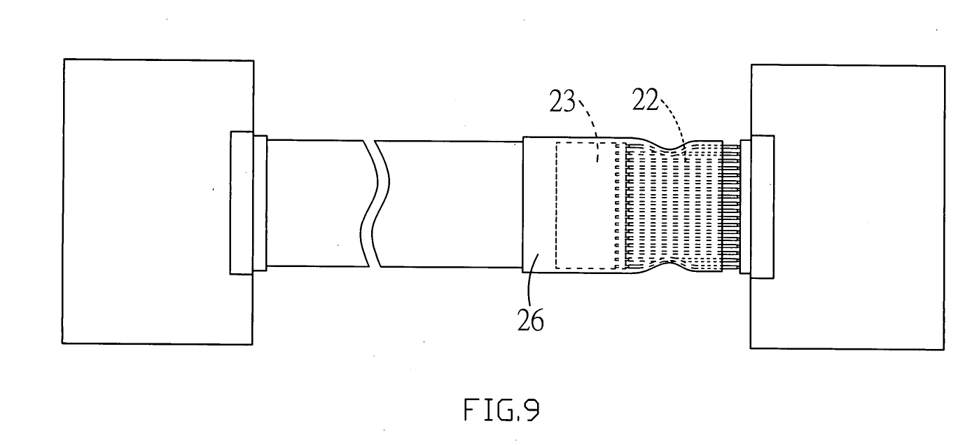

In addition, a protective member 26 can fit over the coaxial lines 22, as illustrated in FIG. 7, or a protective member 26 can fit over the circuit board 23, as illustrated in FIG. 8. It is understood that a protective member 26 can fit over the circuit board and the coaxial lines 22 simultaneously, as illustrated in FIG. 9. The above protective member 26 can be a heat-shrinkable sleeve for covering the coaxial lines and/or the circuit board to provide the shielding and protection effects.

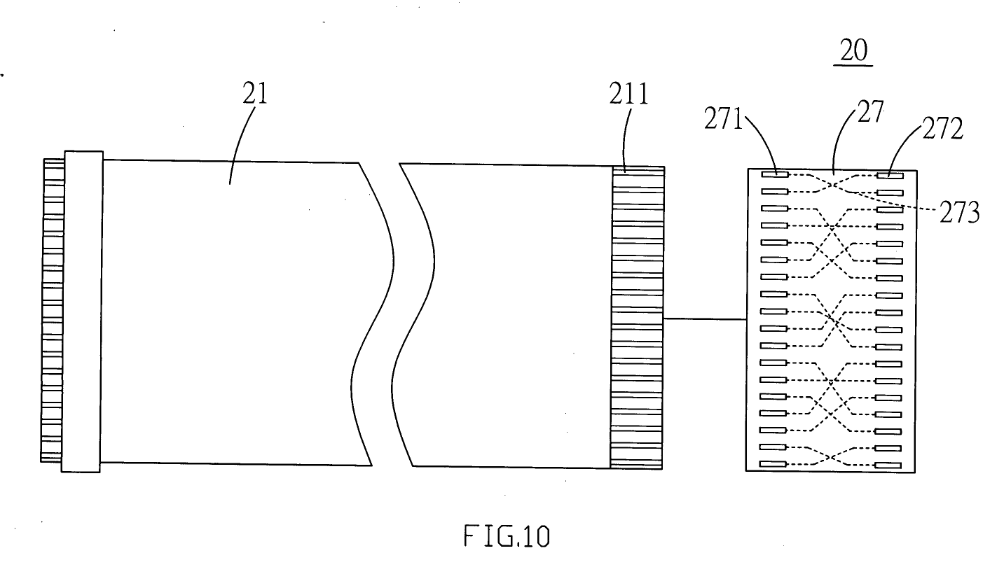

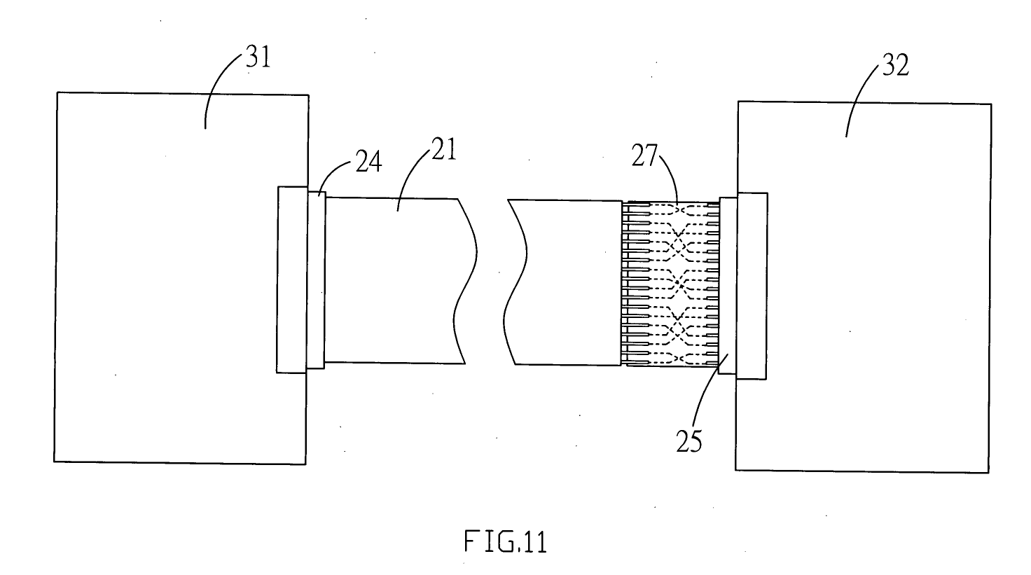

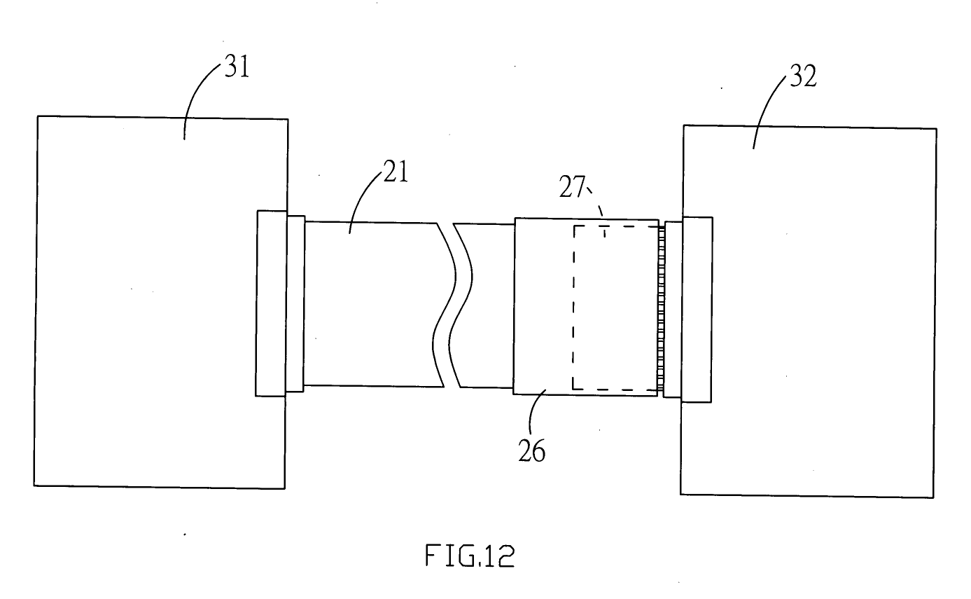

Furthermore, another embodiment of the connecting device for cables and jumper wires, as illustrated in FIG. 10, at least comprises a flexible flat cable 21 and a flexible circuit board 27, wherein the flexible circuit board 27 is provided thereon with a plurality of third pins 271 and fourth pins 272 as well as circuits 273 which are disposed among the third and fourth pins to link them. The arranging order of each third pin 271 differs from that of each fourth pin 272. The flexible flat cable 21 is provided with a plurality of first pins 211 connected to each third pin 271, and the first pins 211 are linked to the third pins 271 for turn-on in a manner of soldering. When the entire connecting device for cables and jumper wires is applied to connect two main bodies, as illustrated in FIG. 11, a first connecting body 24 is disposed at the other end of the flexible flat cable 21 opposed to the flexible circuit board 27. The flexible flat cable 21 is connected to a first main body 31 via the first connecting body 24. A second connecting body 25 is disposed at the other end of the flexible circuit board 27 opposed to the flexible flat cable 21, and the flexible circuit board 27 is connected to a second main body 32 via the second connecting body 25 to connect and transmit signals or electricity between the first main body 31 and the second main body 32. The above first and second connecting bodies can be an ODD (Optical Disc Drive), a SATA (Serial ATA), a HDMI (High-Definition Multimedia Interface), a USB, a D-sub or a LVDS transmission interface. It is understood that a protective member 26 can further fit over the portion between the flexible flat cable 21 and the flexible circuit board 27, as illustrated in FIG. 12. The protective member 26 can be a heat-shrinkable sleeve to provide the shielding and protection effects.

The present invention has the following advantages in comparison with the prior art:

1. The connecting device according to the present invention is suitable for the connection of jumper wires, particularly for employing a flexible flat cable as a connecting device. It can improve the drawback that a flexible flat cable of the prior art cannot serve for a jumper connection.

2. When applied to a flexible flat cable and other connecting members (e.g. a coaxial line or other electronic lines), the present invention can retain the characteristics of high flex resistance and cheapness of a flexible flat cable.

The technical contents and features of the present invention are disclosed above. However, anyone familiar with the technique could possibly make modify or change the details in accordance with the present invention without departing from the disclosure of the invention. Therefore, the protection scope of the present invention shall not be limited to what embodiment discloses, and should include various modification and changes that are made without departing from the present invention, and should be covered by the claims mentioned below.

I claim:

1. A connecting device for cables and jumper wires at least comprising:
a circuit board, which is provided thereon with a plurality of circuits;
a flexible flat cable (FFC), which is provided with a plurality of first pins connected to each of the circuits; and
a second connecting member, which is provided with a plurality of second pins connected to each of the circuits, and the arranging order of each first pin differs from that of each second pin so that the flexible flat cable and the second connecting member are linked to each other and positioned by a circuit board for turn-on, and each of the circuits provides a jumper connection between the flexible flat cable and the second connecting member.

2. The connecting device for cables and jumper wires as claimed in claim 1, wherein the second connecting member is comprised of coaxial lines.

3. The connecting device for cables and jumper wires as claimed in claim 2, wherein a protective member fits over the coaxial lines.

4. The connecting device for cables and jumper wires as claimed in claim 2, wherein a protective member fits over the circuit board and the coaxial lines.

5. The connecting device for cables and jumper wires as claimed in claim 1, wherein the second connecting member is a flexible flat cable.

6. The connecting device for cables and jumper wires as claimed in claim 1, wherein a protective member fits over the circuit board.

7. The connecting device for cables and jumper wires as claimed in claim 1, wherein a first connecting body is disposed at the other end of the flexible flat cable opposed to the second connecting member.

8. The connecting device for cables and jumper wires as claimed in claim 7, wherein the first connecting body is an ODD (Optical Disc Drive), a SATA (Serial ATA), a HDMI (High-Definition Multimedia Interface), a USB, a D-sub or a LVDS transmission interface.

9. The connecting device for cables and jumper wires as claimed in claim 1, wherein a second connecting body is disposed at the other end of the second connecting member opposed to the flexible flat cable.

10. The connecting device for cables and jumper wires as claimed in claim 9, wherein the second connecting body is an ODD (Optical Disc Drive), a SATA (Serial ATA), a HDMI (High-Definition Multimedia Interface), a USB, a D-sub or a LVDS transmission interface.

11. A connecting device for cables and jumper wires at least comprising:
a flexible flat cable (FFC), which is provided with a plurality of first pins; and
a flexible circuit board, which is provided thereon with a plurality of third and fourth pins, and the arranging, order of each third pin differs from that of each fourth pin, and each first pin and each third pin are linked to each other.

12. The connecting device for cables and jumper wires as claimed in claim 11, wherein a protective member fits over the port ion between the flexible flat cable and the flexible circuit board.

13. The connecting device for cables and jumper wires as claimed in claim 12, wherein the protective member is a heat-shrinkable sleeve.

14. The connecting device for cables and jumper wires as claimed in claim 11, wherein a first connecting body is disposed at the other end of the flexible flat cable opposed to the flexible circuit board.

15. The connecting device for cables and jumper wires as claimed in claim 14, wherein the first connecting body is an ODD (Optical Disc Drive), a SATA (Serial ATA), a HDMI (High-Definition Multimedia Interface), a USB, a D-sub or a LVDS transmission interface.

16. The connecting device for cables and jumper wires as claimed in claim 11, wherein a second connecting body is disposed at the other end of the flexible circuit board opposed to the flexible flat cable.

17. The connecting device for cables and jumper wires as claimed in claim 16, wherein the second connecting body is an ODD (Optical Disc Drive), a SATA (Serial ATA), a HDMI (High-Definition Multimedia Interface), a USB, a D-sub or a LVDS transmission interface.

18. The connecting device for cables and jumper wires as claimed in claim 11, wherein circuits are disposed among the third and fourth pins to link the third and fourth pins.
